(19) United States
(12) Patent Application Publication
(10) Pub. No.: US 2011/0253059 A1
(43) Pub. Date: Oct. 20, 2011

(54) Multi-Function Pets Training Tool

(76) Inventor: Kun Bong Wong, Hong Kong (CN)

(21) Appl. No.: 12/763,743

(22) Filed: Apr. 20, 2010

(51) Int. Cl. A01K 15/02

(52) U.S. Cl. 119/702

(57) ABSTRACT

This invention involves a multi-function pets training tool, in particular, it could allow pets to maintain vitality, a tool both enhancing training and entertainment, and to utilize different designs and purpose-made accessories for different results, users could use these accessories in making out different training tools. The training aim of this invention is mainly through a hide-and-seek process to find out the hiding articles as may be pre-concealed by the trainer in the base platform, and the training pets have to use skills of topple over, drive and pull to find out these articles, through these trainings to enhance the agility of pets' muscle, concentration and smelling capabilities. This invention is structurally simple, change of accessories is flexible, which makes the functional training more fun, versatile and varied in fashions, to meet with the pets' psychology of fun inducing and to satisfy fully the curiosity of training pets, meanwhile, it enhances pets' vitality and to keep the pets entertained.

### FIELD OF THE INVENTION

This invention involves an innovative multi-function pets training tool, in particular it is a tool allowing pets to maintain vitality, and provision of both training and entertainment needs for the pets.

BACKGROUND OF THE INVENTION

The main purpose of this pets training tool is to train agility and to make fun for you pets, nowadays, there are quite a number of pet training tools in the market for maintaining vitality, entertaining and stimulating the development of intelligent of pets. For the purpose to maintain interest for a longer time, food or snacks are deposited in the training tool in order to attract pets. Most designs are not to allow pets to finish snacks easily and to induce pets to spend more time on the training tool so as to achieve the training purpose.

All the pets training tools available on the market are of single function or functions in combination, users have to purchase various different products to meet the need in having a multi-functional and versatile training tool. All the above training tools are devoid of methods to adjust the difficulty scales, and this invention is to improve and to pinpoint on these shortcomings.

### SUMMARY OF THE INVENTION

The use of this invention is to provide a versatile, a multi-functional, a stronger interest bearing multi-functional training tool.

This invention employs special accessories of different designs, and the user may utilize these accessories to make out different training tools. The user could use the same base platform, and to add on a little change, then the user may not have to waste time and money in setting up preparatory equipment to conveniently training pets.

The main purposes of this invention is through a hide-and-seek process to make the pets in finding out a pre-concealed article in the base platform, that article could be food or a toy, and these articles would be pre-concealed under different training tools by hiding or concealing, pets in finding out these articles have to topple over, drive and use pulling skills to find them out, through all those trainings to strengthen the muscle vitality, concentration and smelling capability of the pets.

The device of this invention includes a main board and a base shell which made up the base platform. By using concealing cups, concealing saucers, and base covers putting in the base platform as locations for concealing articles, pets could search the concealing articles along the path of a pre-fitted movable sealing board, the sealing board and the base platform when assembled, the edge of the round up board and the base platform will form a hide out path for the concealing cups.

### BRIEF DESCRIPTION OF THE DRAWINGS

FIG. 1 is the structure of this multi-function pets training tool of this invention;

FIG. 2a illustrates the structural implementation of the 1^{st} practice of this multi-function pets training tool;

FIG. 2b illustrates the operational implementation of the 1^{st} practice of this multi-function pets training tool;

FIG. 3a illustrates the structural implementation of the 2^{nd} practice of this multi-function pets training tool;

FIG. 3b illustrates the operational implementation of the 2^{nd} practice of this multi-function pets training tool;

FIG. 4a illustrates the structural implementation of the 3rd practice of this multi-function pets training tool;

FIG. 4b illustrates the operational implementation of the 3rd practice of this multi-function pets training tool;

### DETAILED DESCRIPTION

The following diagrams and implementation practices are to further elaborate on the invention:

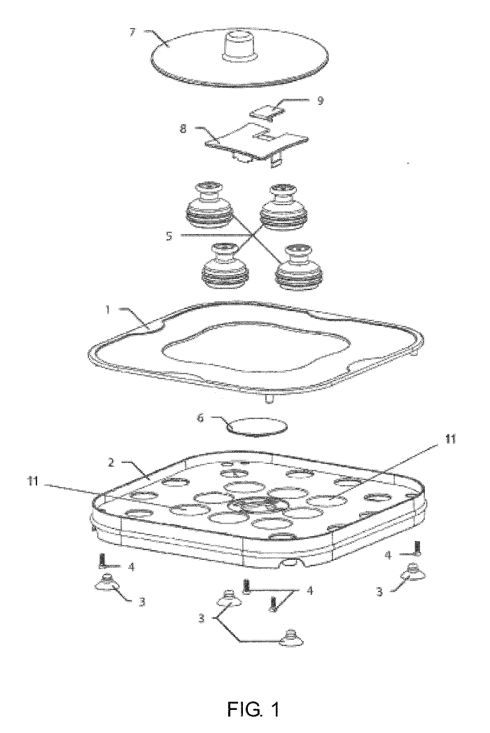

As shown in FIG. 1, this invention of multi-function pets training tool includes main shell board 1, base shell body 2 assembled making up base platform 10, small suction 3 installed under the base shell 2 stationary base platform 10 on the base board, the base shell 2 fitted with hiding holes 11 for hiding concealing cups 5, in the middle of base platform 10 there is a pre-fitted movable slot 9 and a sealing board 8 or they may be replaced by concealing saucers 7 and base covers 6.

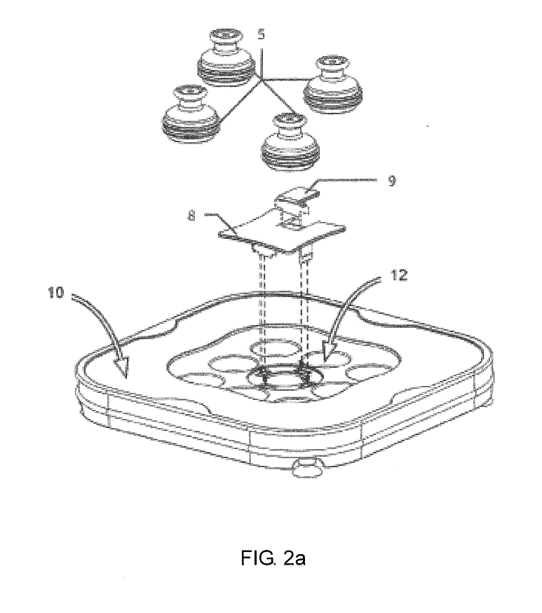

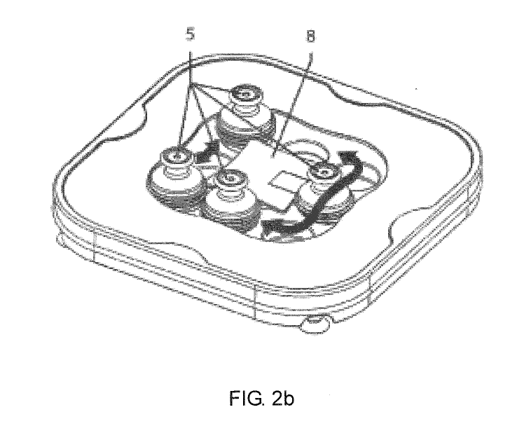

As shown in FIG. 2a, it illustrates the structural implementation of the 1^{st} practice of this multi-function pets training tool. Its assembling method mainly uses concealing cups 5 as a tool in the location to conceal the article on the base platform 10, and to use sealing board 8 as the anchorage for the concealing cups 5, there is a pre-fitted slot 9 on the sealing board 8, users need only round the sealing board 8 in the middle a designated position of the base platform 10, to match with the edge of the sealing board 8 and the inner side of main shell board 1 to make out a track for the concealing cups 5, if move the movable slot 9 to let in the concealing cups 5 into the path, pets may then push the concealing cups 5 and walk along the track.

As shown in FIG. 2b when training pets to use the device, some food or a little toy are to be pre-hided under the base platform 10, and to push the concealing cups 5 to the relevant positions 12 for hiding. When the pets are under training, they will train to learn how to aptly move away these concealing cups 5, and to find out the pre-hided articles.

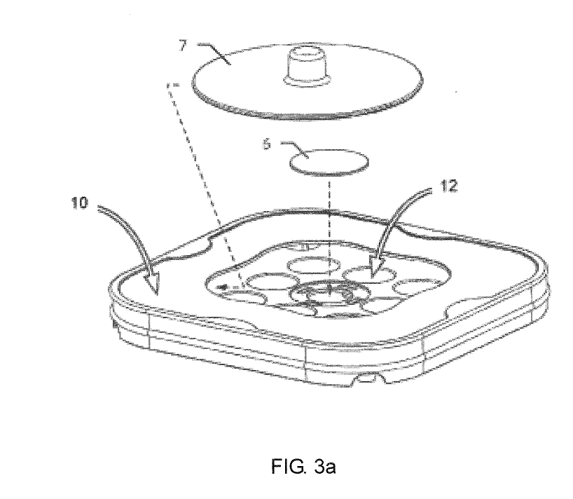

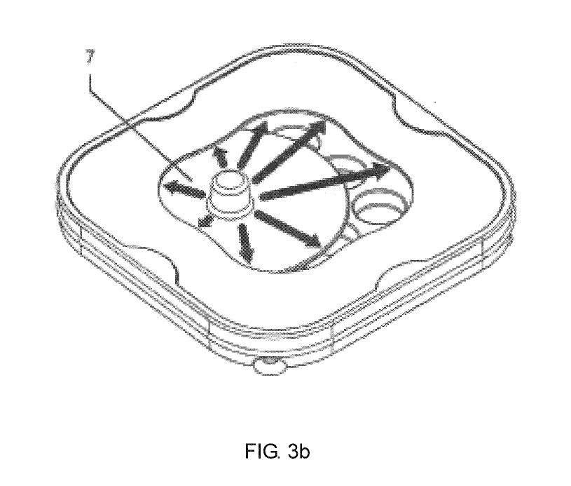

As shown in FIG. 3a which illustrates the structural implementation of the 2^{nd} practice of this multi-function pets training tool, its assembling method is to use concealing saucers 7 as a tool in the location to conceal articles in the base platform 10, firstly, to fix the base covers 6 in the middle of the base platform 10 a designated position, the purpose is to make the concealing saucers 7 more easy to slide, then, hide in the concealing saucers for the game.

As shown in FIG. 3b when training pets to use the device, some food or a little toy are to be pre-hided under the base platform 10, and to push the concealing saucers 7 to the relevant positions 12 for hiding. When the pets are under training, they will train to learn how to aptly move away these concealing saucers 7, and to find out the pre-hided articles.

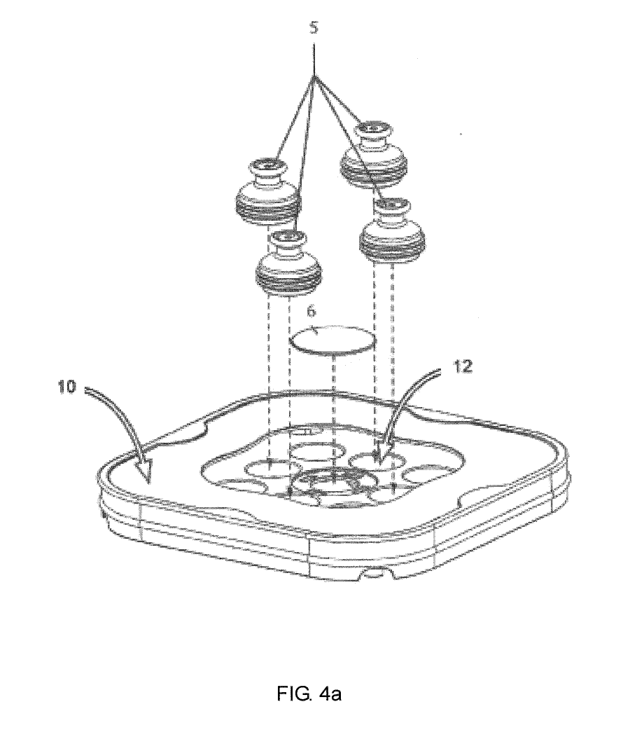

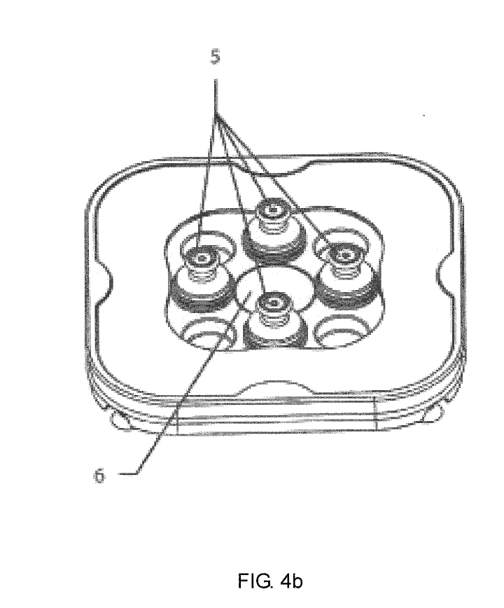

As shown in FIG. 4a, which illustrates the structural implementation of the 3rd practice of this multi-function pets training tool, its assembling method is to use the concealing cups 5 as a tool in the location to conceal the article in the base platform 10, and to fix the base covers 6 in the middle a designated position of the base platform, then to place the concealing cups 5 randomly at the position of the concealing articles in the base platform 10.

As shown in FIG. 4b before training pets to use the device, some food or a little toy are to be pre-hided under the base platform 10, and put the concealing cups 5 in the relevant positions 12 for hiding. As the hiding articles would be fully covered by the concealing cups 5, the pets are to be trained to learn how to sniff out these pre-hided articles.

This invention is structurally simple; change of accessories is flexible, which makes the functional training more fun, versatile and varied in fashions, to meet with the pets' psychology of fun inducing and to satisfy fully the curiosity of training pets, meanwhile, it enhances pets' vitality and to keep the pets entertained.

What is claimed is:

1. A multi-function pets training tool wherein it comprises: main shell board and a base shell body in making up the base platform. The base shell which installed with holes for placing concealed cups uses the concealing cups as the anchorage position for hiding articles in the base platform, in the middle of the base platform there is a pre-fixed movable slot in the sealing board, the sealing board when assembled with the base platform, the edge of the sealing board matched with the base shell to form a track for placing concealed cups, and the pets walk along the track to search for the hiding articles.

2. The multi-function pets training tool according to claim 1, wherein said pets training tool using the same base platform, base covers are fixed in the middle a designated position of the base platform for easy sliding and putting in concealing saucers, pets have to move away the concealing saucers before finding out the pre-concealed articles.

3. The multi-function pets training tool according to claim 1, wherein said pets training tool using the same base platform, base covers are fixed in the middle a designated position of the base platform and the concealing cups are placed randomly in the concealing position of the base platform, the concealing articles are fully covered at the concealing position by the concealing cups, pets are to sniff out the pre-concealed articles by smelling.

4. The multi-function pets training tool according to claim 1, wherein said at the base of the said pets training tool, there is a small suction to anchor the base platform on the floor.

5. The multi-function pets training tool according to claim 1, wherein said the concealing cups of the said pets training tool may be replaced by concealing saucers, base covers and other accessories.

6. The multi-function pets training tool according to claim 5, wherein said concealing cups are to use the skills of topple over, drive and pull by the training pets to find out the concealed articles, so as to enhance the agility of pets' muscle, concentration and smelling capability of the training pets.

7. The multi-function pets training tool according to claim 1, wherein said training tool is using the same base platform coupling with different accessories in making out different training tools.
